(19) United States
(12) Patent Application Publication
(10) Pub. No.: US 2006/0176216 A1
(43) Pub. Date: Aug. 10, 2006

(54) Tracking and timing system

(76) Inventor: Jason C. Hipskind, Fishers, IN (US)

Correspondence Address: CHRISTOPHER E. HAIGH, 2000 N. Lincoln Park West #1203, Chicago, IL, 60614, US

(21) Appl. No.: 11/281,737

(22) Filed: Nov. 16, 2005

Related U.S. Application Data
(60) Provisional application No. 60/628,595, filed on Nov. 17, 2004.

(51) Int. Cl. G01S 1/00

(52) U.S. Cl. 342/357.06

(57) ABSTRACT

An apparatus and methods for tracking an object is disclosed. The apparatus and methods provide for GPS tracking, and can include a communication system that transmits the position of the object to a central database. Software can track the object and provide updates as to the position, speed, course, and other items of interest.

### FIELD OF THE INVENTION

The present invention relates to a tracking and timing system, and particularly to a tracking and timing system that can be employed with tracking objects or individuals engaged in any number of activities including recreation, general fitness, training, races or competitions.

### BACKGROUND OF THE INVENTION

During recreational activities such as family trips to an amusement park, ski trips, camping trips, school field trips, etc. it is easy for individuals to get separated from the group. It can often be difficult, time consuming, and stressful on both the group (leaders and participants) and the individual to go through the location process and ultimately reunite with the family or group. Currently there is no “visible” method for a group or family to monitor participants or to efficiently track and locate participants who have separated from the group.

Many times, a race course (running, triathlon, cycling, boating, skiing, etc.) or competition is set up with checkpoints and turning points. Such checkpoints insure that each participant has completed that leg of the course, and in some cases, that checkpoint serves as a place for the participant to check in for further instructions. The current method of timing for races (particularly running races) consists of RF (radio frequency) timing that is recorded as a participant (who is wearing some kind of RF transmitter) crosses over a pad that energizes or senses the RF transmitter. Once energized, the RF transmitter sends a signal to the receiver in the pad, the signal identifying the race participant. The specific time that the transmission is received is recorded for the race participant. Moreover, the various split times, as well as total race time, are calculated accordingly. Each checkpoint must be equipped with a pad, equipment to collect data, network cables to connect the pad to the equipment, and electricity to power the pad and equipment.

There is also currently no visible method for a race director to monitor race participants on a course of any significant length (i.e. a course that is not run on a ¼ mile oval track). Race directors presently rely on phone and/or radio communication, in-person reports from race participants, and witnessing events live on the course to make determinations on safety and progress of participants through the course. GPS technology has been used primarily for locating and tracking personal assets, vehicles, pets, etc. Furthermore, there have been many GPS systems developed solely for tracking multiple vehicles, such as a fleet of freight trucks, over wide areas.

### SUMMARY OF THE INVENTION

What is disclosed is a system of tracking and timing events and/or individuals using GPS technology. Such an event might include a recreational event, training, or a race, and individuals might include competition participants or other individuals such as a group or family that wishes to keep together or in communication.

Tracking individuals with GPS technology will allow for individuals to be located and followed at all points during any given time (i.e. a trip to an amusement park, a training workout, a race, etc.). The tracking could occur, for example, through a web interface accessible via the Internet. This technology will allow for the active monitoring of individuals during pertinent times.

Specific to recreation events, this technology will allow families and/or group facilitators to actively monitor their family and/or group members while participating in any number of activities. Families can utilize this technology to monitor their children's locations at any time. For example, if a group of people is skiing and one member gets lost this technology will allow the lost participant to be located immediately via the Internet. If someone is caught in an avalanche this technology will track the person's history and will aid rescue and recovery workers in locating the individual as quickly as possible to increase the chance of saving a life. Day care facilities can utilize this technology to keep an accurate record of the individuals in their care throughout the day, with the ability to quickly locate any individuals that go missing. This technology will also provide instant verification of the location (and history of locations) of an individual or object at any point in time.

With regard to running events, this technology will allow race directors to more actively monitor race participants to ensure all participants are safe at all times and to accurately monitor progress of the participants through the course. GPS technology can be used in tandem with a race timing system in order to allow race directors to monitor race participants every step of the way. This will allow for race directors to more accurately and efficiently staff the race course based on how the race participants spread themselves out over the course. Furthermore, participants can have peace of mind knowing that if they are injured or become ill at any point during the race, their lack of progress will alarm the race coordinators, and they will be easily located for medical or emergency assistance.

According to the disclosure, a GPS-based tracking and timing system may comprise any one or more of the following elements or combinations of elements: a GPS receiver, an RF transmitter, a central database, carrier access (cellular, wireless, etc.), Internet access, software that can communicate with one or more of the elements of the system, mapping software, a website, a transmitter, a method to track and capture accruing timing information on race participants, a method of calculating split times and total race times for participants, a method of allowing a race participant to send a “distress signal” to race coordinators, a method of allowing race participants to view their progress in real time or to replay their race via the website or software in the future, a method of allowing for central management of a multitude of races throughout the world at the same time, a method of tracking and capturing location and timing information on any user, a method of accessing information related to an individual's current location via the Internet, a method of accessing information related to the history of a individual's location via the Internet, a method of allowing an individual to send a “distress signal” to a predetermined recipient, and a power source.

The tracking and timing system can be utilized to monitor participant progress in real-time, or it may store the progress to be downloaded at a later time. The system can be utilized to insure that participants have completed all legs of the course (for race and competitive events), and may also be used to monitor the safety of participants. The system provides accurate tracking and timing of participants such that other timing mechanisms may not be required. The system may also provide a method of communicating and displaying information to the race participant, such as current time, current distance, remaining distance, race messages, etc.

Additional features of the invention will become apparent to those skilled in the art upon consideration of the following detailed description of preferred embodiments exemplifying the best mode of carrying out the invention as presently perceived.

### DETAILED DESCRIPTION OF EMBODIMENTS OF THE INVENTION

The GPS Tracking and Timing System can consist of a GPS module, power source, GPS software, a transmitter, race timing software, central data repository accessible via the Internet, software application to be installed on a computer, etc. The GPS module can be attached to the race participant in any number of manners, including, but not limited to, Velcro straps, tied to the participants shoe lace, a wristband, an ankle strap, elastic and or other stretchable material, pinned to the participant's clothing (or vehicle such as boat, bike or car if applicable), placed in a backpack worn by the participant, etc. There are existing GPS modules on the market that can be used to provide the GPS functionality for this timing system. One such GPS module can be found at:

http://www.alltigo.com/lt100.html

This module is called the Alltigo LT100 GPS Module and has been developed by Alltigo (+1 416 352 5430). This module utilizes GSM and GPRS technology but other devices exist and are contemplated that utilize CDMA and other network technology and will be applicable for use with the GPS Tracking and Timing System technology. This picture shows that the size of the Alltigo LT100 GPS Module is approximately that of a pager, and the Alltigo LT100 GPS Module can easily be attached to a participant to transmit the precise location of the participant at all times. This module is an ultra low-powered GPS Module that can be built into separate devices or used as a standalone device. As GPS technology continues to improve, GPS chipsets will continue to get smaller, and necessary power consumption will continue to decrease, therefore increasing the available options for chipsets to use in tandem with this GPS Tracking and Timing System.

The contemplated system may also use MGPS, known as “Adaptive Assisted GPS.” AAGPS incorporates the use of cellular phone towers to provide an even more accurate read in certain locations, such as inside buildings, covered areas, etc.

Another component of this system is GPS software that can track the various GPS modules during the races or recreation events. There are many variations of GPS mapping software that could be used, but the illustrative embodiment utilizes software that allows a race director or organizer to accomplish normal race tasks (if applicable), add the GPS participant tracking component, and incorporate accurate, automated tracking and timing for all race and/or recreation participants. Normal race tasks would include tasks such as: setting up a race, entering participants (or teams if relevant), accepting payment from participants, managing participant (or team if relevant) profiles, etc. Normal recreation tasks would include items such as; setting up participant profiles (family members for instance), assigning device(s) to the specific family members, setting up a notification profile to be notified if a device leaves a certain predetermined boundary, etc. The GPS-based tracking and timing system could incorporate all of these items into one, simple to use, web based (and/or installable) software application.

The software system surrounding the GPS-based tracking and timing system could utilize a custom software solution that provides a GPS-based tracking and timing system characterized in the following manner.

The basis of GPS is “triangulation” from satellites. To “triangulate,” a GPS receiver measures distance using the travel time of radio signals. To measure travel time, a GPS utilizes very accurate timing. Along with distance, the GPS measuring system utilizes knowledge of the location of satellites in space. Furthermore, the system corrects for any delays the signal may experience as it travels through the atmosphere.

One feature of the GPS-based tracking and timing system would be the ability to produce maps from which a race can be set up. There are many different commercially available mapping components such as Maptech, National Geographic and All Topo Maps. Maptech Terrain Navigator and Maptech Terrain Navigator Pro can be found at http://www.gpsnow.com/mttn.htm. National Geographic can be found at http://www.gpsnow.com/wftstates.htm. All Topo Maps can be found at http://www.gpsnow.com/atm.htm.

Software such as that found at these examples can be used as the baseline mapping software to develop the maps to set up all races. Furthermore, waypoints can be set in the software or imported into similar software packages from GPS equipment such as the Garmin eTrex Legend C handheld GPS unit and/or the Garmin ForeRunner series of units found at the Garmin corporate website: http://www.garmin.com/products. Waypoints can be used to set the start of the course, as well as checkpoints along the route and the course finish. The precise time of race participants can be calculated and recorded as they pass each pre-programmed waypoint. Race directors (and other relevant parties) will be able to access the real-time race maps via the Internet to view progress of all race participants. This will eliminate the need for pads, equipment and power to be present to calculate and capture participant split times during races. Waypoints in tandem with this GPS tracking and timing technology will accomplish the same task automatically.

The software of the illustrative embodiment could automatically calculate the precise time of each participant through each established waypoint (split times), as well as calculate the estimated time for the participant (or team) to finish. Furthermore, overall race results could be calculated once participants begin to finish the race. At the option of the race organizers, the software could categorize race participants into various categories, i.e. Men Open, Women Open, Men Over 30 etc., and the participants can be automatically ranked according to their time by the GPS-based race timing system. Additionally, the system can rank other aspects such as lowest to highest time on the course, top 50, etc.

This system will allow for race directors (or other relevant parties) to assign a uniquely identifiable GPS module to all race participants (or teams if relevant). All information pertaining to each uniquely identifiable GPS module is stored securely in the central data repository (database). This information is used during and after the race in order to accumulate the accurate and precise time of each race participant in real-time in relation to the pre-programmed waypoints (checkpoints, start and finish lines, etc.). This accurate timing information can then be used to rank all race participants according to time in the database to determine the race winner. However, as noted above, this can also be broken down in categories as deemed appropriate by race coordinators.

The GPS-based tracking and timing system can be used in tandem with the aforementioned presently available RF technology to further ensure accurate timing of all race participants. In this case, the features relying upon the GPS portion could be the dominant features, while the race timing function could be handled via RF technology. RF technology, cellular phone technology, or any other type of transmitting technology could also be used to transmit signals from the GPS modules to the race coordinators. Such information could include participant position, status (in distress, moving, standing still), percentage of completion of the race, and whether waypoints were avoided. The GPS-based timing system could also be used to receive data (i.e. through cell phone technology, GPS signals, RF technology, or any other similar technology) on the status of other racers, on course information, on emergency information, and on any other type of information.

Alternatively, the GPS-based race tracking and timing system can stand alone without the use of RF technology. This scenario is very different in that using GPS technology and waypoints completely replaces the necessity for RF transmitters, receivers and pads to record accurate times for race participants. In this system, waypoints will be pre-programmed into the centralized software application when a race director (or other relevant individual) sets up the race initially. This eliminates the need for a pad equipped with electricity to be located at each checkpoint along the course. Race directors will now have the freedom to create a free-form course without having to rely on electricity to power the various components necessary for today's race timing systems. The addition of GPS functionality also adds a new layer of race coordination and interaction that is nonexistent today. However, it should be understood that nearly any other form of communication may be used to communicate the position of the user/participant, such as radio frequency, cellular signals, satellite signals, infrared signals, and laser signals.

A receiver may be used to receive signals such as those sent by a transmitter via radio frequency, cellular signals, satellite signals, infrared signals, or laser signals. The receiver may be a pre-existing receiver, such as a cellular tower or RF receiver, or the receiver may be established solely for the specified event or location. The receiver may be configured to receive signals only from a short distance away, such as a receiver positioned at a waypoint or checkpoint on a course, or the receiver may be configured to monitor the position of a participant or object that is far from the receiver. The receiver may also be configured to transmit the received data over the internet so that the data can be used to track the participant or object.

In one illustrative embodiment (the race/competitive example), the system operates as follows:

A race director (or other relevant individual) establishes the race course by setting GPS waypoints into the mapping software via the Internet. The waypoints may be set manually if the individual knows the proper coordinates (latitude and longitude) or may be imported into the system if the individual uses an existing GPS-based piece of equipment such as a Garmin GPS unit.

The mapping software (resident on the central database or accessible via the Internet) automatically creates and displays the course based on the input of the Race Director. The Race Director accepts race participant entries and the system automatically builds the race participant profiles.

GPS modules are then assigned to race participants. The unique GPS module identifiers are recorded and assigned to race participants in the central data repository (database) for reference. On race day, timing clocks (GPS tracking and timing system, backup system, etc.) are synchronized to ensure all timing for the event will be accurate. The race begins and timing for all participants begins (automatically based on the participant crossing the first waypoint, or manually based on the precise time of day that the race begins).

Split times are automatically calculated for each race participant based on their unique GPS Module crossing each waypoint. The system recognizes where each GPS module is on the course at all times. Once a GPS module crosses a waypoint, the precise time is recorded for the individual in the central data repository (database).

Finish time is recorded when the individual crosses the final waypoint and total race time is automatically calculated by the system. Race participants can be ranked according to race category and overall time automatically by the system.

In another embodiment (i.e. a recreation example), the system operates as follows:

A family of 5 is taking a trip to Disney World, and the family wants to insure that all members are accounted for at all times during their visit to the park.

Each member of the family, or in the alternative, selected members of the family (i.e. the kids) are assigned a uniquely identifiable GPS module, and a profile is established for each individual in the central repository via the Internet.

While turned on, the GPS tracking and timing system captures the history and time of the location of each of the individuals wearing the system. If at any point one member of the family is lost or separated, he or she can be immediately located, and the history of their movements can be verified, by logging in to the central repository via the Internet and viewing the mapping component for the specified individual. Of course, this scenario can be extrapolated to any number of different examples in which an individual becomes separated from a group or needs to be located immediately, i.e. hiking or skiing in unpredictable terrain, etc.

Distribution of this system via the Internet (i.e. the accessibility of the maps, importing the waypoints, etc.) can also be made into an installable software application for the user. This system is not restricted to distribution via the Internet, rather, such use is only one method of access for the individual. Furthermore, the system and software can be user-configurable so that users can modify certain aspects of the system. For example, a user may wish to turn off certain features, make certain receivers less receptive, program individual characteristics (i.e. “heart-risk participant”) of the tracked participants, etc. Furthermore, it should be understood that the system can be configured as a subscription service, so that the system could be utilized by only authorized individuals.

While the disclosure is susceptible to various modifications and alternative forms, specific exemplary embodiments thereof have been shown by way of example in the drawings and have herein been described in detail. It should be understood, however, that there is no intent to limit the disclosure to the particular forms disclosed, but on the contrary, the intention is to cover all modifications, equivalents, and alternatives falling within the spirit and scope of the disclosure as defined by the appended claims.

What is claimed is:

1. A method of identifying the position of an object, comprising
coupling a GPS receiver to the object,
coupling a transmitter to the object,
providing a receiver remote from the object, the receiver configured for receiving transmissions from the transmitter,
providing software that utilizes the received transmissions and computes the location of the object based on the received transmissions.

2. The method of claim 1, wherein the transmitter utilizes at least one form of communication selected from the group comprising radio frequency, cellular signals, satellite signals, infrared signals, and laser signals.

3. The method of claim 1, wherein the transmissions are sent over the internet.

4. The method of claim 1, wherein the receiver creates transmission data that is sent over the internet.

5. The method of claim 1, wherein the receiver is positioned at a checkpoint in a race or competition.

6. The method of claim 1, wherein the software is configured to provide a map of the location of the object.

7. The method of claim 1, wherein the software is accessible via the internet.

8. The method of claim 1, wherein the software is configured to provide a subscription service.

9. The method of claim 1, wherein the software is user-configurable.

10. The method of claim 9, wherein the software is configured to permit entry of at least one of the group comprising: a unique GPS identifier, a course map, and a selected activity for participants.

11. A method of tracking the progress of participants in an event, the method comprising
coupling a GPS receiver to each participant,
coupling a transmitter to each participant,
providing a receiver remote from the participant, the receiver configured for receiving transmissions from the transmitter,
providing software that utilizes the received transmissions and
computes the location of the participant based on the received transmissions.

12. The method of claim 11, wherein the transmitter utilizes at least one form of communication selected from the group comprising radio frequency, cellular signals, satellite signals, infrared signals, and laser signals.

13. The method of claim 11, wherein the transmissions are sent over the internet.

14. The method of claim 11, wherein the receiver creates transmission data that is sent over the internet.

15. The method of claim 11, wherein the receiver is positioned at a checkpoint in the event.

16. The method of claim 11, wherein the event is a race or competition.

17. The method of claim 11, wherein the software is configured to provide a map of the location of each participant.

18. The method of claim 11, wherein the software is accessible via the internet.

19. The method of claim 11, wherein the software is user-configurable.

20. The method of claim 19, wherein the software is configured to permit entry of at least one of the group comprising: a unique GPS identifier, a course map, and a selected activity for participants.
